(19) United States
(12) Patent Application Publication
(10) Pub. No.: US 2013/0033366 A1
(43) Pub. Date: Feb. 7, 2013

(54) METHOD AND SYSTEM FOR PROVIDING HAPTIC FEEDBACK OF VARIABLE INTENSITY

(71) Applicants: COLIN ALBRIGHT MCDONOUGH, MOUNTAIN VIEW, CA (US); RICHARD CARL GOSSWEILER, III, SUNNYVALE, CA (US)

(72) Inventors: COLIN ALBRIGHT MCDONOUGH, MOUNTAIN VIEW, CA (US); RICHARD CARL GOSSWEILER, III, SUNNYVALE, CA (US)

(21) Appl. No.: 13/195,728

(22) Filed: Aug. 1, 2011

(51) Int. Cl. H04B 3/36

(52) U.S. Cl. 340/407.1

(57) ABSTRACT

A device includes an actuator that provides haptic feedback in response to a control signal and a controller that outputs the control signal to the actuator. The actuator is in an ON condition when the control signal is at a first voltage and is in an OFF condition when the control signal is at a second voltage. The control signal includes a first time, during which the control signal switches between the first voltage and the second voltage, and a second time, during which the control signal is at the second voltage. During the first time the control signal switches between the first voltage and the second voltage such that the user does not perceive the actuator switching between the ON condition and the OFF condition.

### FIELD

The present disclosure generally relates to a system and method for providing haptic feedback and, more particularly, to a system and method for varying the intensity of haptic feedback in a mobile electronic device.

### BACKGROUND

This section provides background information related to the present disclosure which is not necessarily prior art.

Mobile electronic devices (mobile phones, tablet computers, personal gaming devices, personal digital assistants, etc.) are becoming, or have already become, ubiquitous. From toddlers to senior citizens, everyone has at least one mobile electronic device. Typically, a mobile electronic device includes an element that provides haptic feedback to a user. For example, a mobile phone may vibrate to indicate to a user of an incoming call or text/voice message, a tablet computer may provide a brief movement or vibration to indicate that the user has pressed a specific element on a touch screen (such as a letter on a keyboard), and a personal gaming device may vibrate to indicate when the user has performed some task associated with a video game.

As can be appreciated from the foregoing examples, electronic mobile devices provide numerous types of information to a user by means of haptic feedback. Accordingly, there is a need for a system and method that provides a user with the ability to distinguish what information is being provided by a mobile electronic device through haptic feedback.

### SUMMARY

This section provides a general summary of the disclosure, and is not a comprehensive disclosure of its full scope or all of its features.

In various embodiments of the present disclosure, a device that provides variable intensity haptic feedback to a user is disclosed. The device includes an actuator that provides haptic feedback in response to a control signal and a controller that outputs the control signal to the actuator. The actuator is in an ON condition when the control signal is at a first voltage and is in an OFF condition when the control signal is at a second voltage. The control signal includes a first time, during which the control signal switches between the first voltage and the second voltage, and a second time, during which the control signal is at the second voltage. During the first time the control signal switches between the first voltage and the second voltage such that the user does not perceive the actuator switching between the ON condition and the OFF condition.

In various embodiments of the present disclosure, a computer-readable medium is disclosed. The computer-readable medium is encoded with instructions, which, when executed, cause a processor to perform operations. The operations include providing variable intensity haptic feedback to a user of a device including an actuator, by: (i) providing a control signal to the actuator, the control signal including a first time during which the control signal switches between a first voltage and a second voltage, and a second time during which the control signal is at the second voltage. The actuator can be (i) in an ON condition when the control signal is at a first voltage, and (ii) in an OFF condition when the control signal is at a second voltage. During the first time the control signal switches between the first voltage and the second voltage such that the user does not perceive the actuator switching between the ON condition and the OFF condition.

In various embodiments of the present disclosure, a device that provides variable intensity haptic feedback to a user is disclosed. The device includes an actuator that provides haptic feedback in response to a control signal, a controller that outputs the control signal to the actuator, and a user interface configured to allow the user to adjust the control signal to vary an intensity of haptic feedback perceived by the user. The actuator can be (i) in an ON condition when the control signal is at a first voltage, and (ii) in an OFF condition when the control signal is at a second voltage. The control signal can include a first time during which the control signal switches between the first voltage and the second voltage, and a second time during which the control signal is at the second voltage. The user interface can be configured to allow the user to adjust the control signal to vary an intensity of haptic feedback perceived by the user by controlling the switching between the first voltage and the second voltage during the first time. During the first time, the control signal includes a plurality of first pulses at the first voltage and a plurality of second pulses at the second voltage. The first pulses can have one or more first pulse lengths and the second pulses can have one or more second pulse lengths, wherein the first and second pulse lengths are selected such that the user does not perceive the actuator changing from the OFF condition during the second pulses to the ON condition during the first pulses, and varying the first and second pulse lengths varies the intensity of haptic feedback perceived by the user during the first time.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram illustrating a user and a plurality of electronic mobile devices according to some embodiments of the present disclosure;

FIG. 2 is a block diagram of one of the electronic mobile devices FIG. 1;

FIG. 3 illustrates a control signal according to some embodiments of the present disclosure; and

FIGS. 4 through 6 illustrate other control signals according to some embodiments of the present disclosure;

Corresponding reference numerals indicate corresponding parts throughout the several views of the drawings.

### DETAILED DESCRIPTION

Example embodiments will now be described more fully with reference to the accompanying drawings.

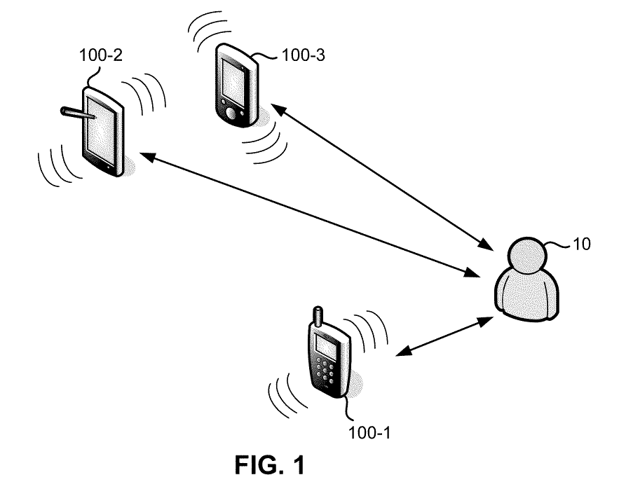

Referring now to FIG. 1, a user 10 may have a plurality of mobile electronic devices, for example, a mobile phone 100-1, a tablet computer 100-2, and a personal digital assistant 100-3. The term “mobile device 100” is used herein to refer to the mobile phone 100-1, tablet computer 100-2, personal digital assistant 100-3 and any other mobile electronic devices (video game controller, etc.) configured to provide haptic feedback to a user 10, as further described below.

As mentioned above, in order to convey information to the user 10, a mobile device 100 can include an element to provide haptic (or tactile) feedback to a user, e.g., through vibration, “bumping” or other movement. This feedback can convey information (incoming call, incoming text/voice message, confirmation of a touch on a touch screen, etc.) to the user 10 in a number of different ways, such as by varying the haptic feedback to indicate different types of information. For example only, the mobile device 100 may indicate an incoming call by a sustained vibration, a confirmation of a touch on a touch screen by a relatively short time of movement/vibration or “bump,” and an incoming message by a plurality of times of separate movement/vibration in quick succession with intervening periods without vibration. In some embodiments of the present disclosure, the mobile device 100 can provide haptic feedback at variable levels of intensity, for example, to distinguish between various types of information being conveyed to the user 10 or to conform to the preference of the user 10. These and other uses for varying haptic feedback fall within the scope of the present disclosure, as described below.

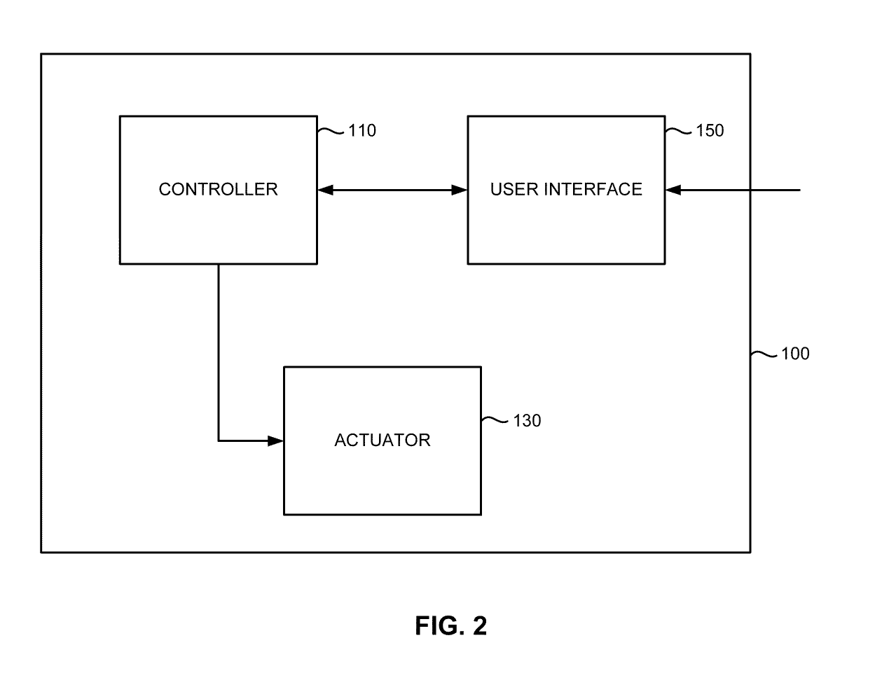

An example mobile device 100 according to some embodiments of the present disclosure is shown in FIG. 2. The mobile device 100 can include a controller 110 coupled to an actuator 130 and a user interface 150. The controller 110 can output a control signal to the actuator 130, which provides haptic feedback (vibration, bumping, movement, etc.) to the user 10 in response thereto. Actuators 130 include, but are not limited to, piezoelectric elements, vibratory motors with an offset rotating mass, electroactive polymers, electrostatic surface actuators, eccentric rotating mass (ERM) actuators and linear resonant actuators.

The user interface 150 can allow the user 10 to interact with the mobile device 100 and controller 110 to adjust the control signal in order to vary the haptic feedback. For example only, the user interface 150 can include a touch screen or other display, an integrated or standalone keyboard, a trackball, joystick, mouse and/or other peripheral input device. The user 10 may utilize the user interface 150 to interact with the controller 110 and the actuator 130, e.g., to input preferences or set the length and/or intensity of a time of haptic feedback.

The actuator 130 provides haptic feedback to a user 10 in response to a control signal output, for example, by the controller 110. The actuator 130 can either be in an ON condition, during which the actuator 130 (and the associated mobile device 100) vibrates or otherwise moves, and an OFF condition, during which the actuator 130 (and the associated mobile device 100) is still. For example, the actuator 130 can be in the ON condition when the control signal is at a first voltage (such as 1.5 or 3 Volts) and in the OFF condition when the control signal at a second voltage (such as 0 Volts). In this manner, the control signal can switch the actuator between the ON condition and the OFF condition by switching between the first voltage and the second voltage. In a non-limiting example, the actuator 130 can be a piezoelectric element having only the ON condition and the OFF condition, i.e., only a vibrating/moving condition (at a single speed/intensity) and a still condition, respectively.

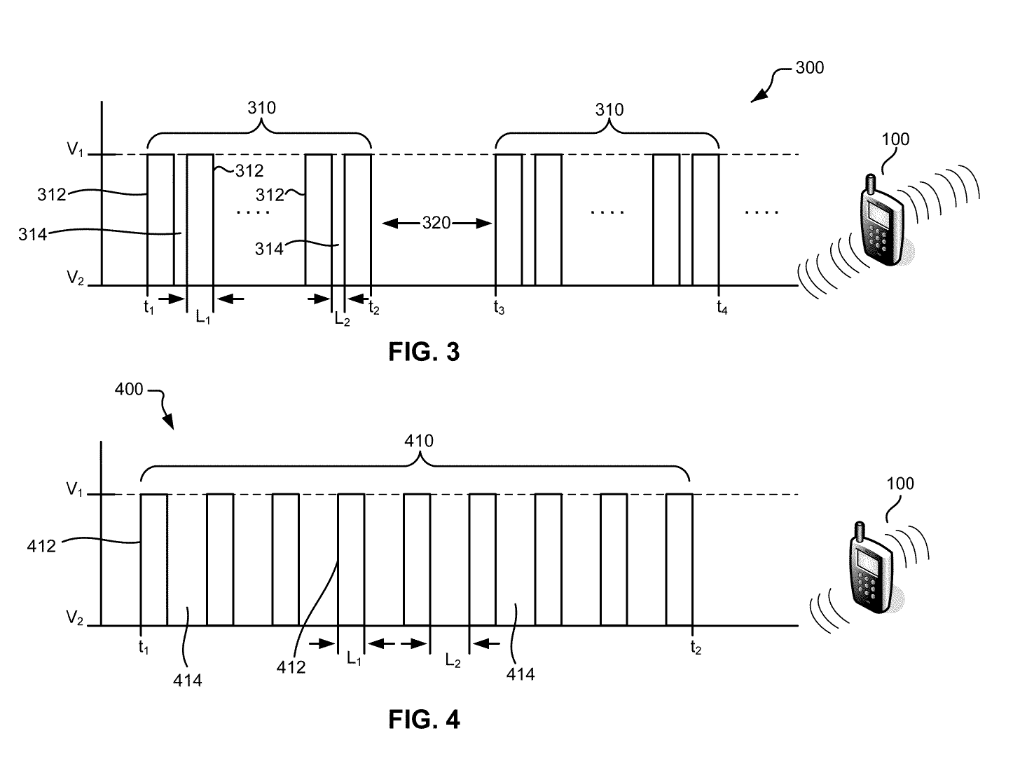

Referring now to FIG. 3, a control signal 300 for controlling the actuator 130 is illustrated. Control signal 300 can include a first time 310 (beginning at a beginning time t₁ and ending at an ending time t₂) during which the control signal 300 switches between a first voltage V₁ and a second voltage V₂. Control signal 300 can further include a second time 320 (beginning at a beginning time t₂ and ending at an ending time t₃) during which the control signal 300 remains at the second voltage V₂. Furthermore, in some embodiments, the control signal 300 can include a plurality of first and second times 310, 320.

As described above, the actuator 130 can be in the ON condition when the control signal 300 is at the first voltage V₁ and in the OFF condition when the control signal is at the second voltage V₂. During the first time 310, the control signal 300 can include one or more first pulses 312 (having a first pulse length L₁) at the first voltage V₁ and one or more second pulses 314 (having a second pulse length L₂) at the second voltage V₂. In various embodiments of the present disclosure, during the first time 310 the control signal 300 switches between the first voltage V₁ and the second voltage V₂ such that the user 10 does not perceive the actuator 130 switching between the ON condition and the OFF condition, as further described below.

A human being, such as the user 10, may not be able to discern short times of a lack of stimulus arranged within times of stimulus. For example, a human being may not be able to discern times of darkness in an intermittent light stimulus if the frequency of switching between light and darkness is above a threshold. This threshold is sometimes referred to as the critical fusion frequency or critical flicker frequency (CFF). An intermittent light stimulus presented at or above the critical flicker frequency will be perceived by a viewer as being continuous, and varying the time period of darkness will instead be perceived by the viewer as varying the intensity (brightness) of the light stimulus.

Similar to the example above in relation to an intermittent light stimulus, a user 10 may not be able to discern a time of lack of motion in a time of intermittent motion stimulation. For example, the user 10 may not be able to discern a time of lack of movement in the actuator 130 of the mobile device 100 if the actuator 130 is switching between the ON condition and the OFF condition at a frequency above a threshold, referred to herein as the “critical fusion frequency for perception of motion” for the user 10. In some embodiments, the critical fusion frequency for perception of motion by a user 10 is approximately within the range of 250-1000 Hertz.

It should be appreciated that the critical fusion frequency for perception of motion by a user 10 may vary based on what body part (hand, leg, etc.) of the user 10 is receiving the stimulus. Thus, in some embodiments of the present disclosure, the critical fusion frequency for perception of motion of a user 10 can be selected based on the critical fusion frequency for a body part that typically will receive the stimulus, or an average or other mathematical combination of critical fusion frequencies for various body parts of the user 10.

Referring again to FIG. 3, the first pulse length L₁ and the second pulse length L₂ of the control signal 300 can be selected to obtain the desired haptic feedback (type, intensity, etc.) for the mobile device 100. For example only, the first and second pulse lengths L₁, L₂ can be selected such that the user 10 does not perceive the actuator 130 changing from the OFF condition during the second pulse 314 to the ON condition during the first pulse 312, and/or vice-versa. Further, varying the first and second pulse lengths L₁, L₂ (for example, by the user 10 interacting with the user interface 150) can vary the intensity of haptic feedback perceived by the user 10 during the first time 310, as described more fully below.

In some cases, the user 10 perceives a change from the OFF condition to the ON condition as an abrupt movement, i.e., a jolt or “bump.” Thus, if the user 10 does not perceive the actuator 130 changing from the OFF condition to the ON condition during the first time 310, the user 10 may perceive the haptic feedback during the first time 310 as a smooth vibration/movement/etc. Additionally, if, during the first time 310, the user 10 does not perceive (1) the actuator 130 changing from the OFF condition to the ON condition and (2) the actuator 130 changing from the ON condition to the OFF condition, the user 10 may perceive the actuator as being in the ON condition continuously during the first time 310.

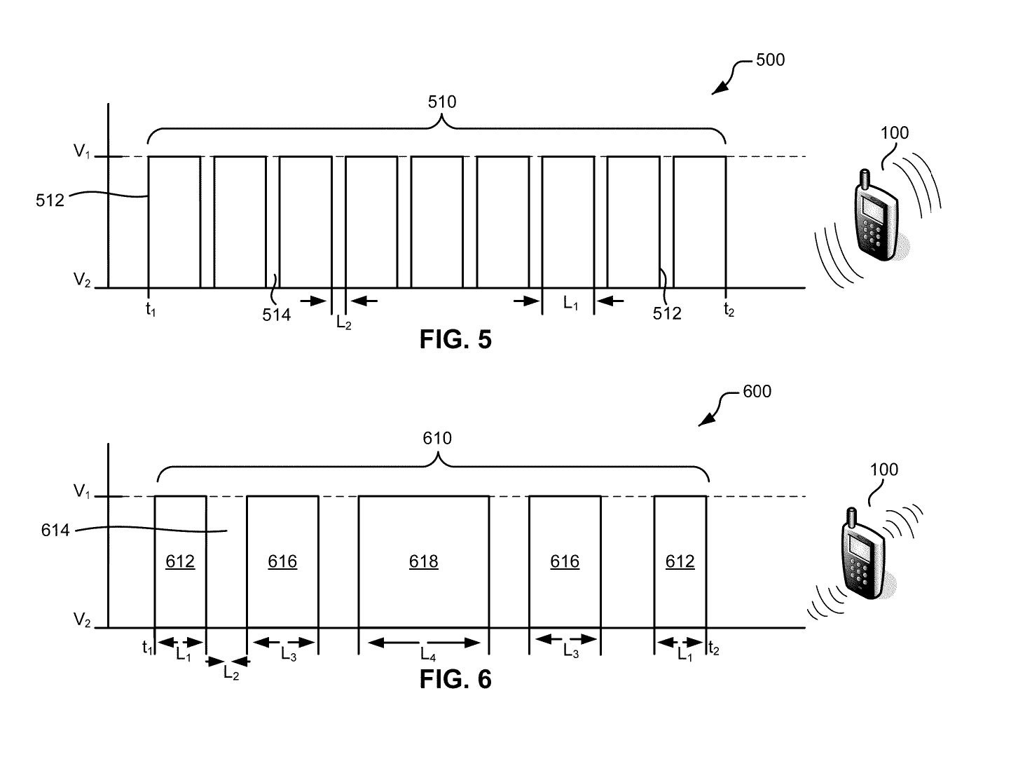

Referring now to FIGS. 4 and 5, control signals 400, 500 for controlling the actuator 130 are illustrated. The control signals 400, 500 are similar to the control signal 300 described above. For example, the control signal 400 can include a first time 410 (beginning at a beginning time t₁ and ending at an ending time t₂) during which the control signal 400 switches between a first voltage V₁ and a second voltage V₂. The control signal 400 can further include a second time (not shown) during which the control signal 400 is at the second voltage V₂. During the first time 410, the control signal 400 can include one or more first pulses 412 (having a first pulse length L₁) at the first voltage V₁ and one or more second pulses 414 (having a second pulse length L₂) at the second voltage V₂. In various embodiments of the present disclosure, during the first time 410 the control signal 400 switches between the first voltage V₁ and the second voltage V₂ such that the user 10 does not perceive the actuator 130 switching between the ON condition and the OFF condition.

Similarly, the control signal 500 can include a first time 510 (beginning at a beginning time t₁ and ending at an ending time t₂) during which the control signal 500 switches between a first voltage V₁ and a second voltage V₂, and a second time (not shown) during which the control signal 500 is at the second voltage V₂. During the first time 510, the control signal 500 can include one or more first pulses 512 (having a first pulse length L₁) at the first voltage V₁ and one or more second pulses 514 (having a second pulse length L₂) at the second voltage V₂. In various embodiments of the present disclosure, during the first time 510 the control signal 500 switches between the first voltage V₁ and the second voltage V₂ such that the user 10 does not perceive the actuator 130 switching between the ON condition and the OFF condition.

When the control signal 400 is provided (for example, by controller 110) to the actuator 130, the user 10 will perceive haptic feedback during the first time 410 at a first intensity. Similarly, when the control signal 500 is provided (for example, by controller 110) to the actuator 130, the user 10 will perceive haptic feedback during the first time 510 at a second intensity. If the control signals 400, 500 switch between the ON condition and the OFF condition at a frequency above critical fusion frequency for perception of motion, the user 10 will not perceive the actuator switching between the ON and OFF conditions, but will instead perceive a difference in intensity of haptic feedback between the two control signals 400, 500. As illustrated, the user 10 will perceive the actuator 130 as providing a higher intensity of haptic feedback in response to the control signal 500 than in response to the control signal 400 because, when comparing the first times 410 and 510, the duty cycle of the control signal 500 is greater than the duty cycle of the control signal 400.

Referring now to FIG. 6, another example control signal 600 for controlling the actuator 130 is illustrated. The control signal 600 is similar to the control signals 300, 400, 500 described above. For example, the control signal 600 can include a first time 610 (beginning at a beginning time t₁ and ending at an ending time t₂) during which the control signal 600 switches between a first voltage V₁ and a second voltage V₂, and a second time (not shown) during which the control signal 600 is at the second voltage V₂. During the first time 610, the control signal 600 can include one or more first pulses 612, 616, 618 at the first voltage V₁ and one or more second pulses 614 at the second voltage V₂. In various embodiments of the present disclosure, during the first time 610 the control signal 600 switches between the first voltage V₁ and the second voltage V₂ such that the user 10 does not perceive the actuator 130 switching between the ON condition and the OFF condition.

As shown in FIG. 6, the first pulse 612 has a first pulse length L₁, the second pulse 614 has a second pulse length L₂, the first pulse 616 has a third pulse length L₃ and the first pulse 618 has a fourth pulse length L₄. The first, third and fourth pulse lengths L₁, L₃, and L₄ are all different lengths and are selected to provide a variation in intensity of haptic feedback perceived by the user 10 from the beginning time t₁ to the ending time t₂ of the first time 610. For example, the first, third and fourth pulse lengths L₁, L₃, and L₄ may be selected to provide a saw tooth pattern of intensity of haptic feedback perceived by the user 10 from the beginning time t₁ to the ending time t₂ of the first time 610.

In various embodiments of the present disclosure, the techniques described herein may be implemented by one or more computer programs executed by one or more processors. The computer programs can, for example, be implemented as a portion of a stand-alone application or as an application programming interface (API) running on a processor of the mobile device 100 (such as controller 110).

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code, or a process executed by a distributed network of processors and storage in networked clusters or datacenters; other suitable components that provide the described functionality; or a combination of some or all of the above, such as in a system-on-chip. The term module may include memory (shared, dedicated, or group) that stores code executed by the one or more processors.

The term code, as used above, may include software, firmware, bytecode and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer-readable medium. The computer programs may also include stored data. Non-limiting examples of the non-transitory tangible computer-readable medium are devices including non-volatile memory, magnetic storage devices, and optical storage devices.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer-readable medium that can be accessed by the computer. Such a computer program may be stored in a tangible computer-readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A device that provides variable intensity haptic feedback to a user, comprising:
an actuator that provides haptic feedback in response to a control signal, the actuator (i) being in an ON condition when the control signal is at a first voltage, and (ii) being in an OFF condition when the control signal is at a second voltage; and
a controller that outputs the control signal to the actuator, the control signal including: (i) a first time during which the control signal switches between the first voltage and the second voltage, and (ii) a second time during which the control signal is at the second voltage, wherein during the first time the control signal switches between the first voltage and the second voltage such that the user does not perceive the actuator switching between the ON condition and the OFF condition.

2. The device of claim 1, wherein, during the first time, the control signal includes a first pulse at the first voltage and a second pulse at the second voltage, the first pulse having a first pulse length and the second pulse having a second pulse length, the first and second pulse lengths being selected such that the user does not perceive the actuator changing from the OFF condition during the second pulse to the ON condition during the first pulse.

3. The device of claim 2, wherein varying the first and second pulse lengths varies an intensity of haptic feedback perceived by the user during the first time.

4. The device of claim 2, wherein the second pulse length is less than a threshold, the threshold being based on a critical fusion frequency for perception of motion of the actuator by the user.

5. The device of claim 2, wherein, during the first time, the control signal further includes a third pulse at the first voltage, the third pulse having a third pulse length different than the first pulse length.

6. The device of claim 1, wherein the user perceives the actuator as being in the ON condition continuously during the first time.

7. The device of claim 1, wherein the actuator comprises a piezoelectric element having only the ON condition and the OFF condition.

8. The device of claim 1, wherein, during the first time, the control signal includes a plurality of first pulses at the first voltage and a plurality of second pulses at the second voltage, the first pulses having one or more first pulse lengths and the second pulses having one or more second pulse lengths, the second pulse lengths being selected such that the user does not perceive the actuator changing from the OFF condition during the second pulses to the ON condition during the first pulses.

9. The device of claim 8, wherein the first time begins at a beginning time and ends at an ending time, the one or more first pulse lengths are selected to provide a variation in an intensity of haptic feedback perceived by the user from the beginning time to the ending time.

10. The device of claim 1, further comprising a user interface configured to adjust the control signal to vary an intensity of haptic feedback perceived by the user by controlling the switching between the first voltage and the second voltage during the first time.

11. A non-transitory tangible computer-readable medium encoded with instructions which, when executed, cause a processor to perform operations comprising:
providing variable intensity haptic feedback to a user of a device including an actuator, by:
providing a control signal to the actuator, the control signal including: (i) a first time during which the control signal switches between a first voltage and a second voltage, and (ii) a second time during which the control signal is at the second voltage,
wherein the actuator: (i) is in an ON condition when the control signal is at a first voltage, and (ii) is in an OFF condition when the control signal is at a second voltage, and
wherein during the first time the control signal switches between the first voltage and the second voltage such that the user does not perceive the actuator switching between the ON condition and the OFF condition.

12. The non-transitory tangible computer-readable medium of claim 11, wherein, during the first time, the control signal includes a first pulse at the first voltage and a second pulse at the second voltage, the first pulse having a first pulse length and the second pulse having a second pulse length, the first and second pulse lengths being selected such that the user does not perceive the actuator changing from the OFF condition during the second pulse to the ON condition during the first pulse.

13. The non-transitory tangible computer-readable medium of claim 12, wherein varying the first and second pulse lengths varies an intensity of haptic feedback perceived by the user during the first time.

14. The non-transitory tangible computer-readable medium of claim 12, wherein the second pulse length is less than a threshold, the threshold being based on a critical fusion frequency for perception of motion of the actuator by the user.

15. The non-transitory tangible computer-readable medium of claim 12, wherein, during the first time, the control signal further includes a third pulse at the first voltage, the third pulse having a third pulse length different than the first pulse length.

16. The non-transitory tangible computer-readable medium of claim 11, wherein the user perceives the actuator as being in the ON condition continuously during the first time.

17. The non-transitory tangible computer-readable medium of claim 11, wherein, during the first time, the control signal includes a plurality of first pulses at the first voltage and a plurality of second pulses at the second voltage, the first pulses having one or more first pulse lengths and the second pulses having one or more second pulse lengths, the second pulse lengths being selected such that the user does not perceive the actuator changing from the OFF condition during the second pulses to the ON condition during the first pulses.

18. The non-transitory tangible computer-readable medium of claim 17, wherein the first time begins at a beginning time and ends at an ending time, the one or more first pulse lengths are selected to provide a variation in an intensity of haptic feedback perceived by the user from the beginning time to the ending time.

19. A device that provides variable intensity haptic feedback to a user, comprising:
an actuator that provides haptic feedback in response to a control signal, the actuator (i) being in an ON condition when the control signal is at a first voltage, and (ii) being in an OFF condition when the control signal is at a second voltage;
a controller that outputs the control signal to the actuator, the control signal including: (i) a first time during which the control signal switches between the first voltage and the second voltage, and (ii) a second time during which the control signal is at the second voltage; and
a user interface configured to allow the user to adjust the control signal to vary an intensity of haptic feedback perceived by the user by controlling the switching between the first voltage and the second voltage during the first time, wherein:
during the first time, the control signal includes a plurality of first pulses at the first voltage and a plurality of second pulses at the second voltage,
the first pulses have one or more first pulse lengths and the second pulses have one or more second pulse lengths,
the first and second pulse lengths are selected such that the user does not perceive the actuator changing from the OFF condition during the second pulses to the ON condition during the first pulses, and
varying the first and second pulse lengths varies the intensity of haptic feedback perceived by the user during the first time.

20. The device of claim 19, wherein the user perceives the actuator as being in the ON condition continuously during the first time.
